(19) United States
(12) Patent Application Publication
(10) Pub. No.: US 2012/0325064 A1
(43) Pub. Date: Dec. 27, 2012

(54) THE SHEET BLANKING METHOD THAT USED CUTTING MACHINE

(75) Inventor: Kyong Taik LEE, Daegu (KR)

(73) Assignee: YOUNG SHIN MACHINERY CO., LTD., Daegu (KR)

(21) Appl. No.: 13/531,125

(22) Filed: Jun. 22, 2012

(30) Foreign Application Priority Data
Jun. 23, 2011 (KR) 10-2011-0061352

(51) Int. Cl. B26D 7/02; B26F 1/00

(52) U.S. Cl. 83/23

(57) ABSTRACT

Disclosed is a method of punching a sheet using a register. Front and lateral marks (Q, R) of a sheet (S) are sensed, error values are calculated by a CPU (155), and front and lateral levers (135, 137) are actuated accordingly. Front and lateral edges (J, K) of the sheet (S) are not used as references, but front and lateral marks (Q, R) are used as references, so that a pattern (P) is brought into accurate conformity with a mold (131) and then cut off.

### TECHNICAL FIELD

The present invention relates to a method of punching a sheet using a register, and more particularly, to a method of punching a sheet using a register, which can punch a sheet accurately by pushing a gripper, which holds the sheet, by levers so that the sheet is positioned in conformity with the mold.

### BACKGROUND ART

Related prior art will now be described with reference to the accompanying drawings.

FIG. 1 is a top view of a conventional punching machine; FIG. 2 is a sectional view taken along line A-A′ of FIG. 1; FIG. 3 is a perspective view of a gripper of a conventional punching machine, which holds a sheet; FIG. 4 is a top view of a gripper of a conventional punching machine, which holds a sheet, and which is supported by front levers; FIG. 5 is a top view of a gripper, which holds a sheet having patterns and marks rotated clockwise, and which is supported by front levers; FIG. 6 magnifies a part of a sheet having patterns and marks rotated clockwise; and FIG. 7 illustrates processes of a method of punching a sheet using a register according to the prior art. These figures will be referred to in the following description.

In general, a punching machine 1 refers to a machine adapted to cut sheets S, such as corrugated cardboards and strawboards, along the edges of unfolded shapes to manufacture boxes of various shapes.

Such a punching machine 1 includes a sheet supply unit 10 adapted to supply cut sheets one by one; an alignment unit 20 adapted to align a sheet S supplied through the sheet supply unit 10 by pushing the sheet in forward and lateral directions; a punching unit 30 adapted to pressurize the sheet S, which has been supplied through the alignment unit 20, by a mold; and a transfer unit 40 adapted to grasp the sheet S at the alignment unit 20, transfer it to the punching unit 30, and discharge the punched sheet S.

The alignment unit 20 has a conveyor 21 adapted to transfer a sheet S, which has been supplied from the sheet supply unit 10, to the center of the alignment unit 20; and rollers mounted to push the sheet S in the forward and lateral directions, respectively. The rollers are adapted to push the sheet S while pressurizing it downwards.

The transfer unit 40 includes rails 41 fixed to an inner surface of one side of the punching machine 1 and to an inner surface of the opposite side thereof, respectively; chains 43 circulating along the rails 41; and a gripper 45 connected to both chains 43 to circulate together with them and hold the sheet S. The gripper 45 includes a bar 46 fixed to both chains 43 and fingers 47 fixed to the bar 46 and adapted to grip the sheet S like forceps.

The punching unit 30 has a mold 31 positioned on its lower portion and adapted to reciprocate vertically and a surface plate 33 positioned on its upper portion to limit the upward movement of the mold 31. The mold 31 is adapted to have the same height as the front portion of the alignment unit 20, when descended, so that, when the gripper 45 advances, the sheet S is naturally positioned on the upper surface of the mold 31.

The sheet S has a number of patterns P printed thereon, which correspond to the unfolded shapes of boxes, and marks Q and R printed along its periphery in the shape of short lines. The marks Q and R are printed together with the patterns P. When the marks Q and R are positioned at predetermined locations on the upper surface of the mold 31, the mold 31 and the patterns P conform to each other accurately. Then, the patterns P can be accurately cut off along the contour.

A method for punching a sheet using the conventional punching machine 1, which has the above-mentioned construction, will now be described.

A sheet S is supplied through the sheet supply unit 10 to the alignment unit 20 in a sheet supply step. The sheet S introduced through the sheet supply unit 10 is transferred by the conveyor 21 and positioned at the center of the alignment unit 20, and the rollers are actuated to push the sheet S to be close to the front and lateral sides of the alignment unit 20 in an alignment step. In this case, the marks Q and R are not used as references, but a front edge J and a lateral edge K of the sheet S, which are positioned close to the front and lateral sides of the alignment unit, are used as references. The gripper 45 holds the front portion of the sheet S in a gripping step. In addition, the gripper 45 transfers to the upper surface of the mold 31 in a transfer step. In this case, the gripper 45 stops before it reaches a predetermined location, and levers 35 unilaterally push the gripper 45 forwards from behind it until it reaches the predetermined location.

The mold 31 ascends and pressurizes the sheet S against the surface plate 33 so that the patterns P are cut off in a punching step. The punched sheet S is held by the gripper 45 and then discharged in a discharge step. The discharged sheet S is easily separated into patterns P and peripheries U.

### DISCLOSURE

### Technical Problem

According to the prior art, when the gripper is transferred to the punching unit after the front and lateral edges of the sheet are regarded as references in the alignment step, the pattern of the sheet and the mold are supposed to conform to each other. This means that accurate punching is possible if the two front marks on both sides are at a predetermined distance from the front edge and if the lateral mark is at a predetermined distance from the lateral edge, as in the case of FIG. 4.

However, if the patterns are rotated clockwise or counterclockwise or pushed in the backward or lateral direction, as in the case of FIG. 5 or 6, and then printed together with the marks, the front and lateral marks are not at a predetermined distance from the front and lateral edges, respectively. That is, the distances L and M deviate from the specified values, as in the case of FIG. 6.

If the gripper holds the sheet in this state and transfers it to the predetermined location, the contour of the mold (indicted by dotted lines) and that of the pattern do not coincide, making accurate punching impossible and causing defects.

This problem occurs because the front and lateral edges of the sheet are used as references during punching, not the marks.

### Technical Solution

In accordance with an aspect of the present invention, there is provided a method of punching a sheet using a register by a punching machine including a sheet supply unit adapted to supply cut sheets one by one; an alignment unit adapted to align a sheet supplied through the sheet supply unit by pushing the sheet in front and lateral directions; a punching unit adapted to pressurize the sheet supplied through the alignment unit by a mold; and a transfer unit adapted to hold the sheet at the alignment unit, transfer the sheet to the punching unit, and discharge the punched sheet, the method including the steps of supplying a sheet to the alignment unit through the sheet supply unit; aligning the sheet supplied in the supplying step to be close to front and lateral sides of the alignment unit; measuring a distance between marks printed on both sides of a front portion of the sheet and a front edge of the sheet and a distance between a mark printed on a lateral portion of the sheet and a lateral edge of the sheet; calculating an error value by comparing the measurement value with a reference value; gripping the sheet by a gripper; transferring the gripper to the punching unit and stopping the gripper; adjusting a push amount by pushing the gripper as much as the error value; punching the sheet by raising the mold; and holding the sheet by the gripper, discharging the sheet, releasing the sheet, and returning to the aligning step.

In the measuring step, cameras and a CPU adapted to receive data from the cameras are mounted on the alignment unit so that the CPU recognizes images of the marks through the cameras and measures a distance value between marks printed on both sides of the front portion of the sheet and a front edge of the sheet and a distance value between a mark printed on a lateral portion of the sheet and a lateral edge of the sheet; in the step of calculating an error value, the CPU compares the distance value with a reference value to calculate a difference value; and, in the step of adjusting a push amount, a servomotor adjusts an amount of forward movement of front and lateral levers, and the CPU actuates the servomotor so that the front and lateral levers move forwards as much as the error value and push the gripper.

### Advantageous Effects

The method for punching a sheet using a register according to the present invention is advantageous as follows: the front and lateral marks of a sheet are sensed, error values are calculated by the CPU, and the front and lateral levers are operated accordingly. This means that not the front and lateral edges of the sheet, but the front and lateral marks are used as references, so that the pattern is brought into accurate conformity with the mold and then cut off.

### BRIEF DESCRIPTION OF THE DRAWINGS

FIG. 1 is a top view of a conventional punching machine;

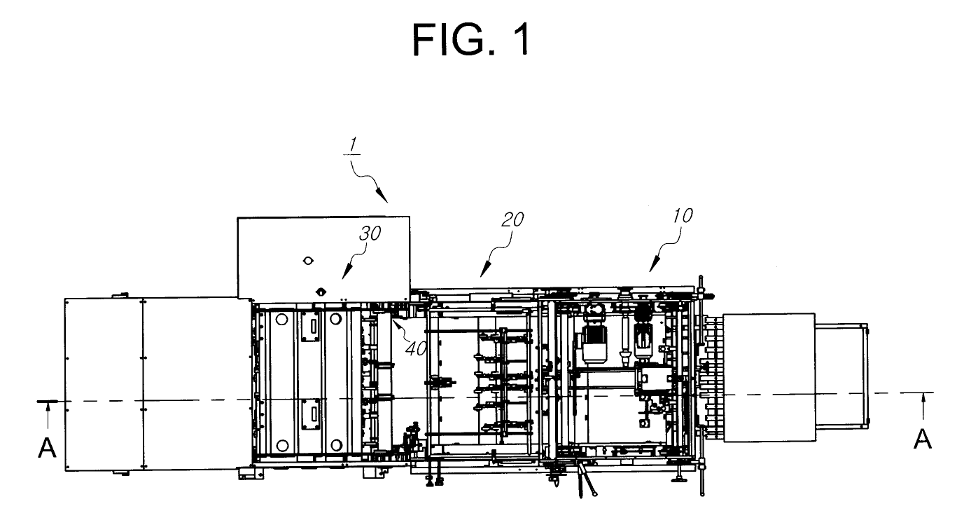

FIG. 2 is a sectional view taken along line A-A′ of FIG. 1;

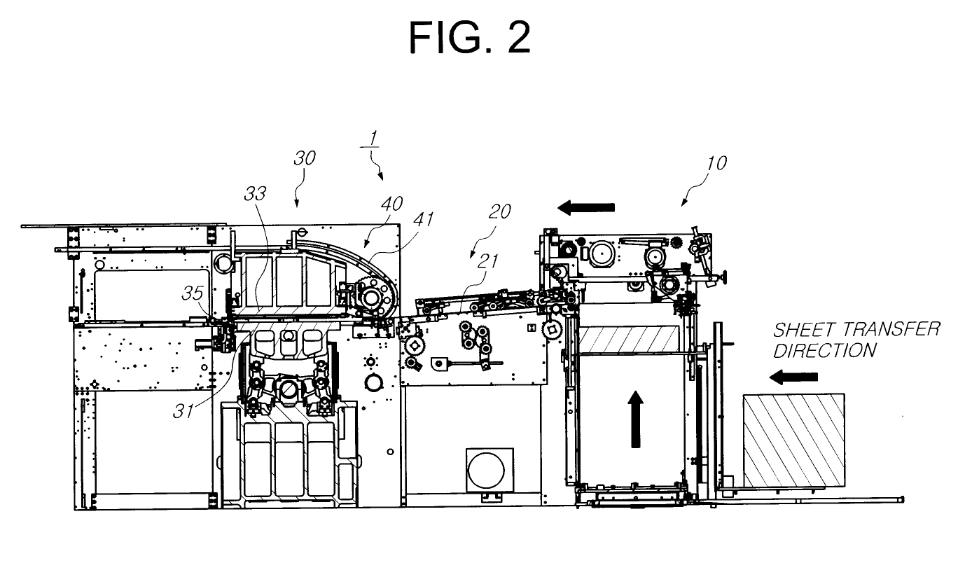

FIG. 3 is a perspective view of a gripper of a conventional punching machine, which holds a sheet;

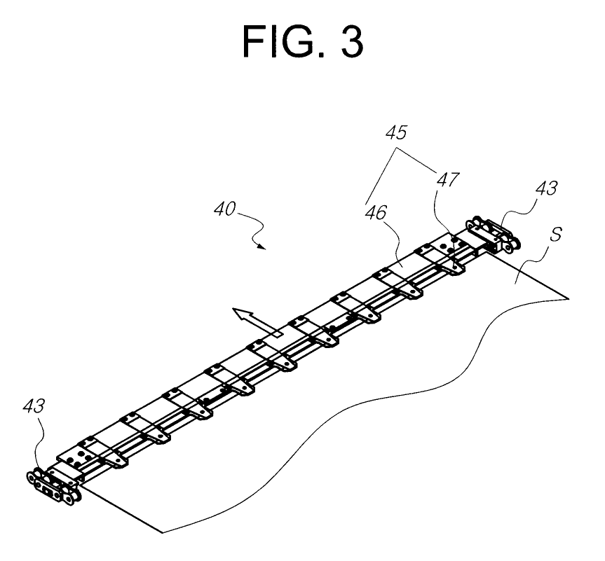

FIG. 4 is a top view of a gripper of a conventional punching machine, which holds a sheet, and which is supported by front levers;

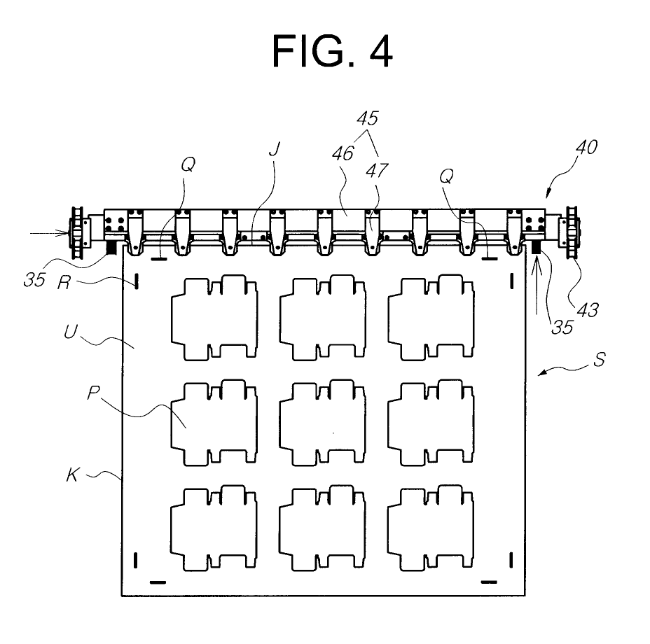

FIG. 5 is a top view of a gripper, which holds a sheet having patterns and marks rotated clockwise, and which is supported by front levers;

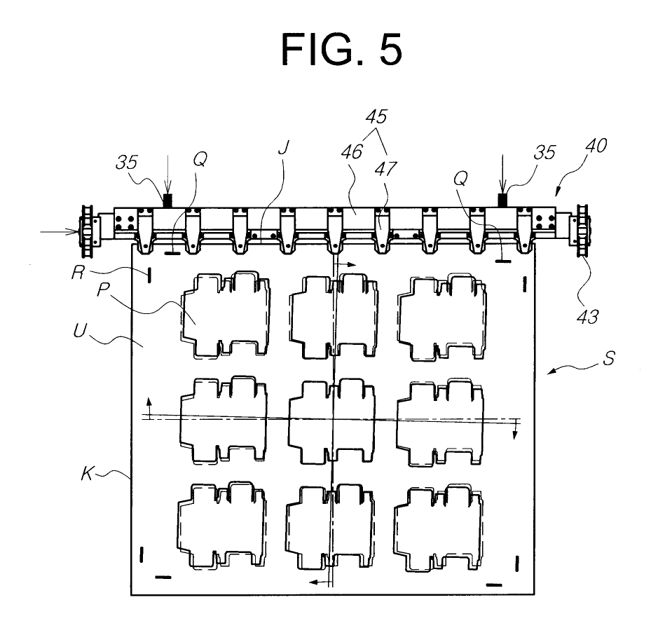

FIG. 6 magnifies a part of a sheet having patterns and marks rotated clockwise;

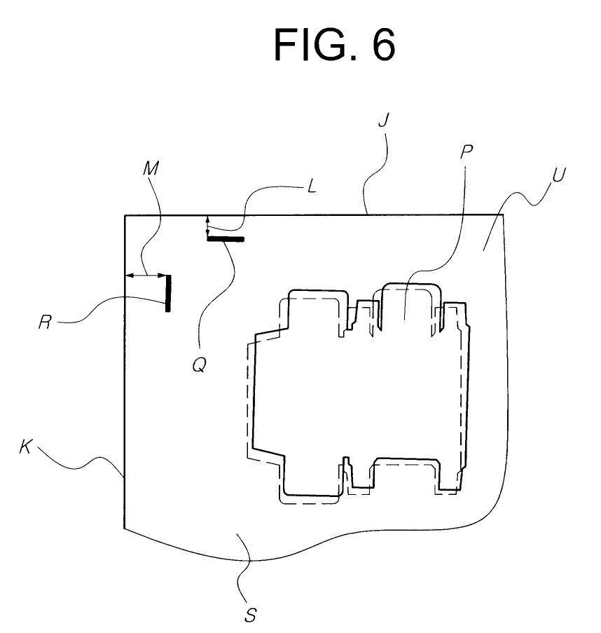

FIG. 7 illustrates processes of a method of punching a sheet using a register according to the prior art;

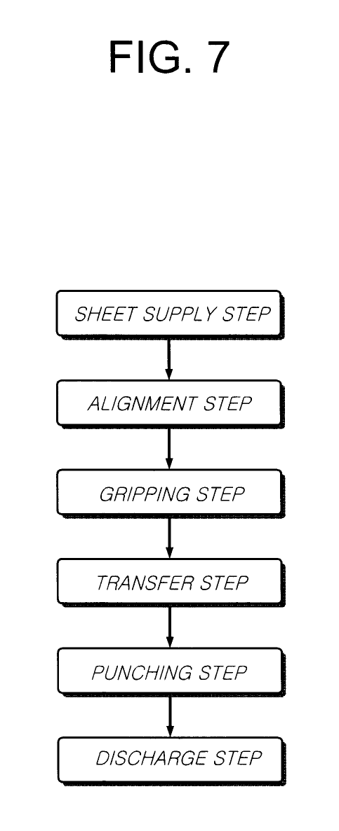

FIG. 8 is a perspective view of a punching machine enabling a method of punching a sheet using a register according to the present invention;

FIG. 9 is a local perspective view illustrating front and lateral cameras mounted on an alignment unit of a punching machine enabling a method of punching a sheet using a register according to the present invention;

FIG. 10 is a perspective view illustrating front and lateral levers mounted on a punching unit of a punching machine enabling a method of punching a sheet using a register according to the present invention;

FIG. 11 is a block diagram illustrating a control unit for driving front and lateral levers of a punching machine enabling a method of punching a sheet using a register according to the present invention;

FIG. 12 illustrates processes of a method of punching a sheet using a register according to the present invention; and

FIG. 13 is a top view illustrating a process of pushing a gripper to adjust the position of a sheet in a method of punching a sheet using a register according to the present invention.

### MODE FOR CARRYING OUT THE INVENTION

A method of punching a sheet according to the present invention, which has been made to solve the above-mentioned problems, will now be described with reference to the accompanying drawings.

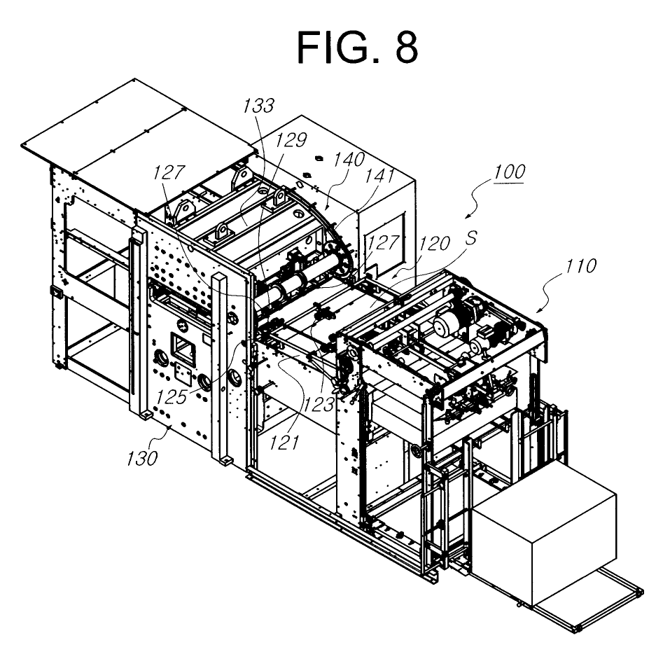

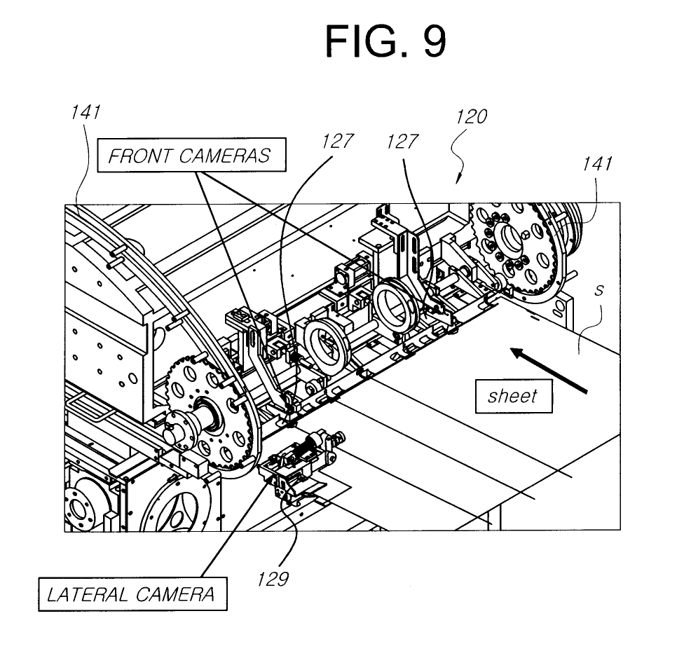

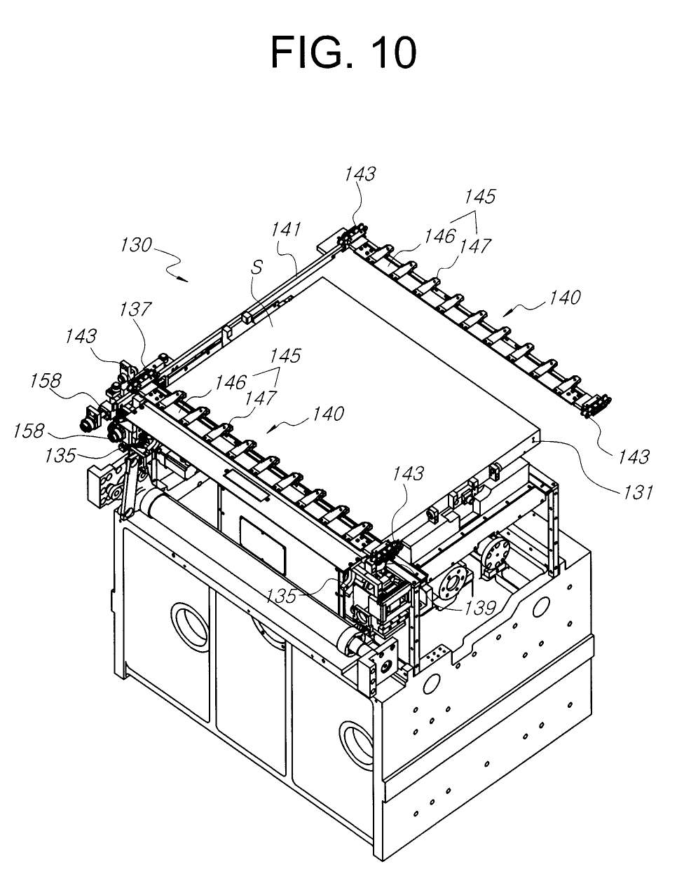

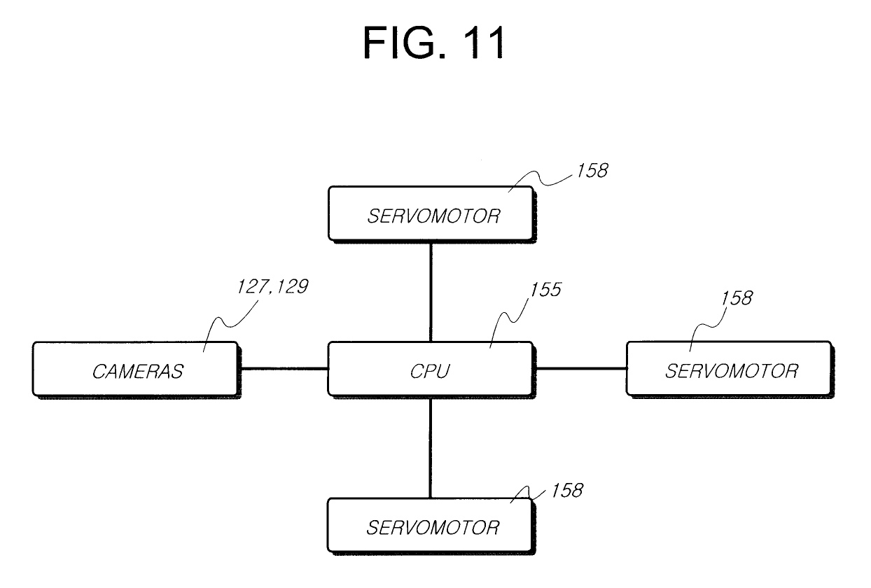

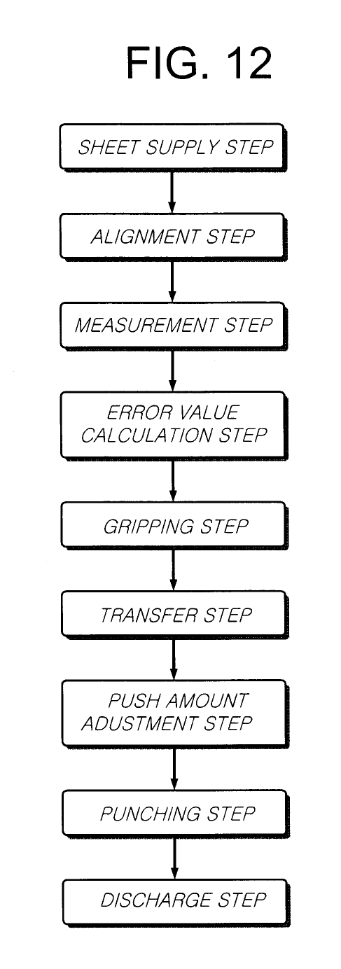

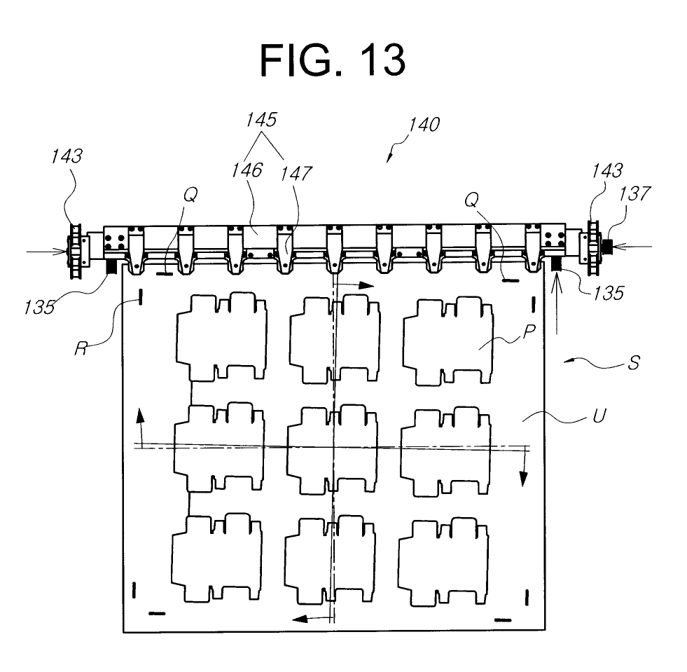

FIG. 8 is a perspective view of a punching machine enabling a method of punching a sheet using a register according to the present invention; FIG. 9 is a local perspective view illustrating front and lateral cameras mounted on an alignment unit of a punching machine enabling a method of punching a sheet using a register according to the present invention; FIG. 10 is a perspective view illustrating front and lateral levers mounted on a punching unit of a punching machine enabling a method of punching a sheet using a register according to the present invention; FIG. 11 is a block diagram illustrating a control unit for driving front and lateral levers of a punching machine enabling a method of punching a sheet using a register according to the present invention; FIG. 12 illustrates processes of a method of punching a sheet using a register according to the present invention; and FIG. 13 is a top view illustrating a process of pushing a gripper to adjust the position of a sheet in a method of punching a sheet using a register according to the present invention. These figures will be referred to in the following description.

The present invention is characterized in that, when a sheet S is punched, a front edge J and a lateral edge K of the sheet S are not used as references, but marks Q and R printed on both sides of the front portion and on a lateral portion are used as references to position a pattern P printed on the sheet S in accurate conformity with the mold 131 and then cut it off.

To this end, the present invention employs a conventional punching machine 100, which will now be described.

In general, the punching machine 100 includes a sheet supply unit 110 adapted to supply cut sheets S one by one; an alignment unit 120 adapted to align a sheet S, which is supplied through the sheet supply unit 110, by pushing it in forward and lateral directions; a punching unit 130 adapted to pressurize the sheet, which has been supplied through the alignment unit 120, by a mold 131; and a transfer unit 140 adapted to hold the sheet S at the alignment unit 120, transfer it to the punching unit 130, and discharge the punched sheet S.

The sheet supply unit 110 is, for example, a conventional device which uses a drawing plate to draw a sheet S, advances to the alignment unit 120, pushes the sheet S into it, releases the sheet S, moves back, and draws another sheet S to be supplied.

The alignment unit 120 includes a conveyor 121 adapted to transfer a sheet S to the upper surface of the alignment unit 120 and rollers 123 and 125 mounted on the alignment unit 120 and positioned above the conveyor 121 to push the sheet S in forward and lateral directions. One roller 123 is mounted on the front portion of the alignment unit 120 to push the sheet S towards the front portion, and the other roller 125 is mounted on a lateral portion of the alignment unit 120 to push the sheet S towards the lateral portion.

The transfer unit 140 includes rails 141 fixed to an inner surface of one side of the punching machine 100 and to an inner surface of the other side thereof, respectively; chains 143 adapted to circulate along the rails 141; and a conventional gripper 145 connected to both chains 143 and adapted to circulate and hold the sheet S. The gripper 145 includes a bar 146 connected to both chains 143 and fingers 147 fixed to the bar 146 to hold the sheet S.

The punching unit 130 includes a mold 131 positioned on its lower side and adapted to reciprocate vertically and a surface plate 133 positioned over the mold 131 to limit the upward movement of the mold 131. Stop levers (not shown) are positioned on both sides of the front of the punching unit 130 to stop the gripper 145 from advancing. Front levers 135 are positioned on both sides to push the gripper 145 from behind the gripper 145. The front levers 135 are operated in such a manner that, when the gripper 145 transfers to the punching unit 130, they push the gripper 145 forwards from behind the gripper 145 as much as the error value, as in the case of FIG. 13.

In addition, a lateral lever 137 is provided to pressurize the gripper 145 from one side of the front portion of the punching unit 130, and a push 139 is provided to push the gripper 145 from the opposite side of the lateral lever 137. The push 139 is, for example, an expansion spring. The front levers 135 are shaft-coupled and adapted to rotate forwards/backwards, and the lateral lever 137 is shaft-coupled and adapted to rotate leftwards/rightwards.

A method of punching a sheet using the punching machine 100, which has the above-mentioned construction, will now be described.

A sheet S is supplied through the sheet supply unit 110 to the alignment unit 120 in a sheet supply step.

The sheet S supplied in the sheet supply step is brought close to front and lateral sides of the alignment unit 120 in an alignment step. The alignment unit 120 has a conveyor 121 to transfer the sheet S, which is introduced from the sheet supply unit 110, forwards so that the sheet S is seated on the upper portion of the alignment unit 120; the front roller 123, which is forced against the sheet S, pushes it forwards; and the other roller 125 pushes the sheet S laterally. As a result, the sheet S is brought close to the front and lateral portions of the alignment unit 120.

After the alignment step, the distance between the front edge J of the sheet S and the front mark Q and the distance between the lateral edge K and the lateral mark R are measured in a measurement step.

The measurement value obtained in the measurement step is compared with an original reference value to calculate an error value in an error value calculation step.

The gripper 145 holds the sheet S in a gripping step. The gripper 145 circulates along the chains 143 and holds the sheet S when positioned near the front of the sheet S.

The gripper 145 is transferred to the punching unit 130 in a transfer step. The stop levers (not shown) stops the gripper 145 from advancing, so that it always stops at a predetermined position. The stop levers (not shown) are conventional devices adapted to stop the transfer of the gripper 145, when raised, and then allow the transfer of the gripper 145 when lying down.

The front and lateral levers 135 and 137 are pushed as much as the error value, after reference setup, in a push amount adjustment step. The position and angle of the gripper 145 are varied by the front and lateral levers 135 and 137, so that the sheet S is seated in conformity with the mold 131.

Particularly, the front and lateral levers 135 and 137 twist or push the gripper 145 laterally so that the sheet S and the mold 131 conform to each other with the front and lateral marks Q and R spaced from the front and lateral edges J and K of the sheet S, respectively, by a reference value.

This means that, if the position of the front and lateral marks Q and R printed on the sheet S differ from the reference value, the amount of forward transfer of the front lever 135 and the amount of lateral transfer of the lateral lever 137 can be adjusted so that the pattern P of the sheet S and the mold 131 coincide.

For example, when the patterns P printed on the sheet are rotated clockwise as shown in FIG. 13, the front lever 135 to the right of FIG. 13 advances along the arrow, and the lateral lever 137 also advances, so that the sheet S is rotated in the opposite direction (i.e. counterclockwise), and the patterns P conform to the mold 131. The front lever 135 on the left side does not advance when the error value is zero.

Assuming, for another example, that the patterns P have moved backwards in parallel as much as f and have moved in a lateral direction (towards the push 139) as much as j, the front levers 135 move forwards (in the direction of transfer of the sheet) as much as f, and the lateral lever 137 moves towards the other side as much as j. The gripper 145 then pushes the lateral lever 137 by means of the push 139.

After the push amount adjustment step, the mold 131 is lifted to punch the sheet S in a punching step.

Furthermore, after the push amount adjustment step, the gripper 145 holds the sheet S, discharges it, releases it, and then returns to the alignment step in a discharge step. The front levers 135 are lowered so that the gripper 145 can enter again.

The discharged sheet S is separated into patterns P and peripheries U.

The measurement step, the error value calculation step, and the push amount adjustment step can be carried out according to an embodiment as follows:

The front and lateral levers 135 and 137 of the punching machine 100 are connected to a servomotor 158 so that the amount of rotation is adjusted. In addition, cameras 127 are mounted on both sides of the front portion of the alignment unit 120 to monitor the lower side and recognize front marks Q on both sides of the front portion of the sheet S, and a camera 129 is mounted on one side of the front portion to monitor the lower side and recognize a lateral mark R on a side of the front portion of the sheet S.

The punching machine 100 further includes a CPU 155 which, after images of the marks Q and R are recognized through the cameras 127 and 129, measures values of distance between the marks Q printed on both sides of the front of the sheet S and the front edge of the sheet, respectively, and a value of distance between the mark R printed on a lateral portion of the sheet S and a lateral edge of the sheet, compares the distance values with reference values to calculate error values, and rotates the servomotor 158 in the forward/backward direction as much as the error values.

In the measurement step, the CPU 155 measures distance values through the cameras 127 and 129, and, in the error value calculation step, the CPU 155 compares the measured distance values with reference values to calculate error values. In the push amount adjustment step, the servomotor 158 is actuated to adjust the amount of rotation of the front and lateral levers 135 and 137.

According to the present invention, front and lateral marks Q and R of a sheet S are sensed, error values are calculated by the CPU 155, and the front and lateral levers 135 and 137 are operated accordingly. Front and lateral edges J and K of the sheet S are not used as references, but the front and lateral marks R and Q are used as references. This is advantageous in that patterns P can be cut off accurately.

1. A method of punching a sheet using a register by a punching machine (100) comprising:
a sheet supply unit (110) adapted to supply cut sheets (S) one by one;
an alignment unit (120) adapted to align a sheet (S) supplied through the sheet supply unit (110) by pushing the sheet (S) in front and lateral directions;
a punching unit (130) adapted to pressurize the sheet supplied through the alignment unit (120) by a mold (131); and
a transfer unit (140) adapted to hold the sheet (S) at the alignment unit (120), transfer the sheet (S) to the punching unit (130), and discharge the punched sheet (S), the method comprising the steps of:
supplying a sheet to the alignment unit (120) through the sheet supply unit (110);
aligning the sheet (S) supplied in the supplying step to be close to front and lateral sides of the alignment unit (120);
measuring a distance between marks (Q) printed on both sides of a front portion of the sheet (S) and a front edge (J) of the sheet (S) and a distance between a mark (R) printed on a lateral portion of the sheet (S) and a lateral edge (K) of the sheet (S);
calculating an error value by comparing the measurement value with a reference value;
gripping the sheet (S) by a gripper (145);
transferring the gripper (145) to the punching unit (130) and stopping the gripper (145);
adjusting a push amount by pushing the gripper (145) as much as the error value;
punching the sheet (S) by raising the mold (131); and
holding the sheet (S) by the gripper (145), discharging the sheet (S), releasing the sheet (S), and returning to the aligning step.

2. The method as claimed in claim 1, wherein, in the measuring step, cameras (127, 129) and a CPU (155) adapted to receive data from the cameras (127, 129) are mounted on the alignment unit (120) so that the CPU (155) recognizes images of the marks (Q, R) through the cameras (127, 129) and measures a distance value between marks (Q) printed on both sides of the front portion of the sheet (S) and a front edge of the sheet and a distance value between a mark (R) printed on a lateral portion of the sheet (S) and a lateral edge of the sheet,
in the step of calculating an error value, the CPU (155) compares the distance value with a reference value to calculate a difference value, and
in the step of adjusting a push amount, a servomotor (158) adjusts an amount of forward movement of front and lateral levers (135, 137), and the CPU (155) actuates the servomotor (158) so that the front and lateral levers (135, 137) move forwards as much as the error value and push the gripper (145).
